(19) United States
(12) Patent Application Publication
(10) Pub. No.: US 2025/0173113 A1
(43) Pub. Date: May 29, 2025

(54) ELECTRONIC DEVICE FOR PROVIDING CONTINUE-WATCHING FUNCTION FOR CONTENT, AND CONTROL METHOD THEREFOR

(71) Applicant: SAMSUNG ELECTRONICS CO., LTD., Suwon-si (KR)

(72) Inventors: Changhoon PARK, Suwon-si (KR); Junggeun KIM, Suwon-si (KR)

(73) Assignee: SAMSUNG ELECTRONICS CO., LTD., Suwon-si (KR)

(21) Appl. No.: 19/038,074

(22) Filed: Jan. 27, 2025

Related U.S. Application Data
(63) Continuation of application No. PCT/KR2023/007852, filed on Jun. 8, 2023.

(30) Foreign Application Priority Data
Jul. 29, 2022 (KR) 10-2022-0094965

(51) Int. Cl. G06F 3/14; G06F 3/04842

(52) U.S. Cl. CPC G06F 3/1454; G06F 3/04842

(57) ABSTRACT

An electronic device comprising a communication interface, a display, and a processor. The processor identifies an external electronic device storing information of a user account that is stored in the electronic device, from among at least one external electronic device enabled to communicate with the communication interface; based on a user input executing an application of the of the identified external electronic device being received, controls the display to display a UI for inquiring whether the electronic device is enabled to provide content provided through an application of the identified external electronic device. The processor, upon a user input requesting provision of content being received through the UI, controls, information related to the content received from the identified external electronic device to be displayed so that content to be provided from the identified external electronic device is displayed through the application executed in the electronic device.

### CROSS-REFERENCE TO RELATED APPLICATION

This is application is a continuation application is a continuation application, under 35 U.S.C. § 111(a), of international application No. PCT/KR2023/007852, filed Jun. 8, 2023, which claims priority under 35 U. S. C. § 119 to Korean Patent Application No. 10-2022-0094965, filed Jul. 29, 2022, the disclosures of which are incorporated herein by reference in their entireties.

### TECHNICAL FIELD

The present disclosure relates to an electronic device for providing a continue-watching function for content and a control method therefor.

### BACKGROUND ART

An electronic device may transmit content provided by the electronic device to another device.

### DISCLOSURE

### Technical Solution

According to an aspect of the present disclosure, an electronic device may include a communication interface, a display, and a processor. The processor is configured to identify an external electronic device storing information related to a user account that is stored in the electronic device from among at least one external electronic device enabled to perform communication with the communication interface. The processor is configured to control the display to display a user interface (UI) for inquiring whether the electronic device is enabled to provide content provided through an application of the identified external electronic device based on a user input for executing the application of the electronic device being received. The processor is configured to control the display to display the content provided from the identified external electronic device, through the application executed on the electronic device, based on the inquiring resulting in the electronic device being enabled to provide the content provided through the application of the identified external electronic device. The display is controlled to display the information related to the content received from the identified external electronic device upon a user input requesting provision of the content being received through the UI.

According to another aspect of the present disclosure, a control method for an electronic device for providing a continue-watching function for content includes: identifying an external electronic device storing a user account that is stored in an electronic device from among at least one external electronic device enabled to perform communication with the electronic device; displaying a UI for inquiring whether the electronic device is enabled to provide content provided through an application of the identified external electronic device based on a user input executing an application of the electronic device being received; and displaying the content provided from the identified external electronic device, through the application executed on the electronic device, based on the inquiring resulting in the electronic device being enabled to provide the content provided through the application of the identified external electronic device, wherein the display is controlled to display information related to the content received from the identified external electronic device upon a user input requesting provision of the content is received through the UI.

According to still another aspect of the present disclosure, there is provided a non-transitory computer-readable medium storing a computer instructions that cause an electronic device to perform an operation when executed by a processor of an electronic device, in which the operation includes identifying an external electronic device storing a user account that is stored in an electronic device from among at least one external electronic device enabled to perform communication with the electronic device; displaying a UI for inquiring whether the electronic device is enabled to provide content provided through an application of the identified external electronic device based on a user input executing an application of the electronic device being received; and displaying the content provided from the identified external electronic device, through the application executed on the electronic device, based on the inquiring resulting in the electronic device being enabled to provide the content provided through the application of the identified external electronic device, wherein the display is controlled to display information related to the content received from the identified external electronic device upon a user input requesting provision of the content being received through the UI.

### BRIEF DESCRIPTION OF DRAWINGS

FIG. 1 is a diagram for describing an electronic device according to an embodiment of the present disclosure.

FIG. 2 is a block diagram for describing a configuration of the electronic device according to an embodiment of the present disclosure.

FIGS. 3, 4, 5A-5B, 6A-6C, 7A-7B and 8 to 13 are diagrams for describing a method for providing a continue-watching function for content according to an embodiment of the present disclosure.

FIG. 14 is a block diagram for describing a detailed configuration of the electronic device according to an embodiment of the present disclosure.

FIG. 15 is a flowchart for describing a control method for an electronic device for providing a continue-watching function for content according to an embodiment of the present disclosure.

### MODE FOR INVENTION

Because the disclosure may be variously modified and have several embodiments, specific embodiments of the disclosure will be illustrated in the drawings and be described in detail in a detailed description. However, it is to be understood that the disclosure is not limited to specific embodiments, but include various modifications, equivalents, and/or alternatives according to embodiments of the disclosure. Throughout the accompanying drawings, similar components will be denoted by similar reference numerals.

In describing the present disclosure, when it is determined that a detailed description for the known functions or configurations related to the present disclosure may unnecessarily obscure the gist of the present disclosure, the detailed description therefor will be omitted.

In addition, the following embodiments may be modified in multiple different forms, and the scope and spirit of the disclosure are not limited to the following embodiments. Rather, these embodiments make the disclosure thorough and complete, and are provided to completely transfer a technical spirit of the disclosure to those skilled in the art.

Terms used in the disclosure are used only to describe specific embodiments rather than limiting the scope of the disclosure. Singular forms include plural forms unless the context clearly indicates otherwise.

In the specification, an expression “have”, “may have”, “include”, “may include”, or the like, indicates existence of a corresponding feature (for example, a numerical value, a function, an operation, a component such as a part, or the like), and does not exclude existence of an additional feature.

In the disclosure, an expression “A or B”, “at least one of A and/or B”, or “one or more of A and/or B”, may include all possible combinations of items enumerated together. For example, “A or B”, “at least one of A and B”, or “at least one of A or B” may indicate all of 1) a case where at least one A is included, 2) a case where at least one B is included, or 3) a case where both of at least one A and at least one B are included.

Expressions “first” or “second” used in the disclosure may indicate various components regardless of a sequence and/or importance of the components, will be used only to distinguish one component from the other components, and do not limit the corresponding components.

When it is mentioned that any component (for example, a first component) is (operatively or communicatively) coupled with/to or is connected to another component (for example, a second component), it is to be understood that any component is directly coupled to another component or may be coupled to another component through the other component (for example, a third component).

On the other hand, when it is mentioned that any component (for example, a first component) is “directly coupled” or “directly connected” to another component (for example, a second component), it is to be understood that the other component (for example, a third component) is not present between any component and another component.

An expression “configured (or set) to” used in the disclosure may be replaced by an expression “suitable for”, “having the capacity to” “designed to”, “adapted to”, “made to”, or “capable of” depending on a situation. A term “configured (or set) to” may not necessarily mean “specifically designed to” in hardware.

Instead, in some situations, an expression “apparatus configured to” may mean that the apparatus may “do” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

In embodiments, a ‘module’ or a ‘˜er/or’ may perform at least one function or operation, and be implemented by hardware or software or be implemented by a combination of hardware and software. In addition, a plurality of “modules” or a plurality of “˜ers/ors” may be integrated in at least one module and be implemented by at least one processor except for a ‘module’ or an ‘˜er/or’ that needs to be implemented by specific hardware.

Meanwhile, various elements and regions in the drawings are schematically illustrated. Therefore, the spirit of the disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

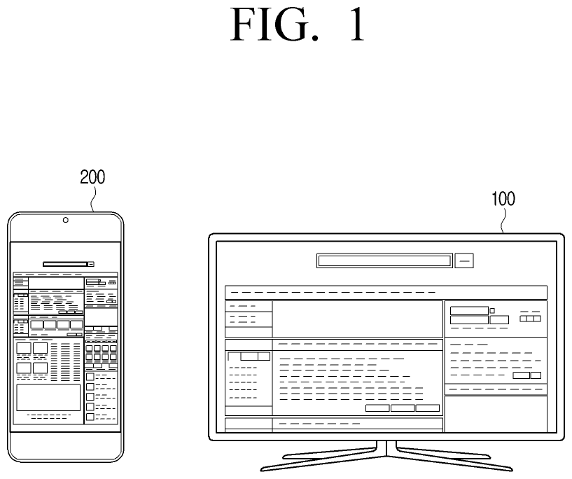

FIG. 1 is a diagram for describing an electronic device according to an embodiment of the present disclosure.

Referring to FIG. 1, an electronic device 100 may be implemented as a TV. However, this is only an example, and the electronic device 100 may be implemented as various types of devices equipped with a display, such as a smartphone, a tablet PC, an e-book reader, a desktop PC, a laptop PC, a netbook computer, and a refrigerator.

The electronic device 100 may communicate with an external electronic device. For example, the electronic device 100 may communicate with an external electronic device existing around the electronic device 100 using Bluetooth low energy (BLE).

In addition, the electronic device 100 may identify an external electronic device that has the same user account as a user account stored in the electronic device 100 among the external electronic devices communicating with the electronic device 100.

Here, the user account may be a user account for logging into a server that provides various services. For example, the user account may be an email address, a phone number, etc. That is, a user may access a website provided by a server through an Internet network using the electronic device 100 and the external electronic device, and log into a website through the user account to receive various services.

In this case, the electronic device 100 and the external electronic device may store information on the input user account. Accordingly, the electronic device 100 may receive the information on the user account stored in the external electronic device from the external electronic device, compare the received user account with the user account stored in the electronic device 100, and identify the external electronic device that stores the same user account as the user account stored in the electronic device 100.

In addition, the electronic device 100 may provide content provided through an application installed in the identified external electronic device through an application installed in the electronic device 100. In the present disclosure, it may be assumed that the application installed in the electronic device 100 is also installed in the external electronic device.

For example, as illustrated in FIG. 1, it is assumed that the user account stored in the external electronic device 200 is the same as a user account stored in an electronic device 100, and a web page is displayed through a web browser application in the external electronic device 200. In this case, the electronic device 100 may receive a URL for a web page from the external electronic device 200, and receive and display a web page using the received URL.

In this way, to log into the server, the electronic device 100 may identify another electronic device to which the same user account as that of the electronic device 100 is input, and may continue to provide content provided through the application in the identified electronic device. Accordingly, a continue-watching function for content may be provided to improve user convenience.

Hereinafter, a specific method for providing a continue-watching function for content will be described.

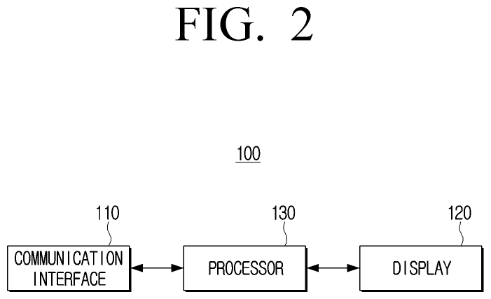

FIG. 2 is a block diagram for describing a configuration of the electronic device according to an embodiment of the present disclosure.

Referring to FIG. 2, the electronic device 100 includes a communication interface 110, a display 120, and a processor 130.

The communication interface 110 includes a circuit. The communication interface 110 may communicate with the external electronic device. To this end, the communication interface 110 may include a BLE communication module. Accordingly, the communication interface 110 may discover the external electronic device around the electronic device 100 and may be connected to the external electronic device for communication. Accordingly, the communication interface 110 may communicate with the external electronic device through a network. In addition, the communication interface 110 may communicate with a plurality of external electronic devices. To this end, the communication interface 110 may include a plurality of BLE communication modules.

The display 120 may display an image. To this end, the display 120 may be implemented as various types of displays, such as LCD, LED, or OLED.

The processor 130 controls the overall operation of the electronic device 100. Specifically, the processor 130 is connected to components of the electronic device 100 including the communication interface 110 and the display 120, and may control the overall operation of the electronic device 100 by executing at least one instruction stored in the memory. In this case, the processor 130 may be implemented not only as one processor, but also as a plurality of processors. Meanwhile, the term processor 130 in the present disclosure may be used as a meaning including a central processing unit (CPU), an application processor (AP), etc.

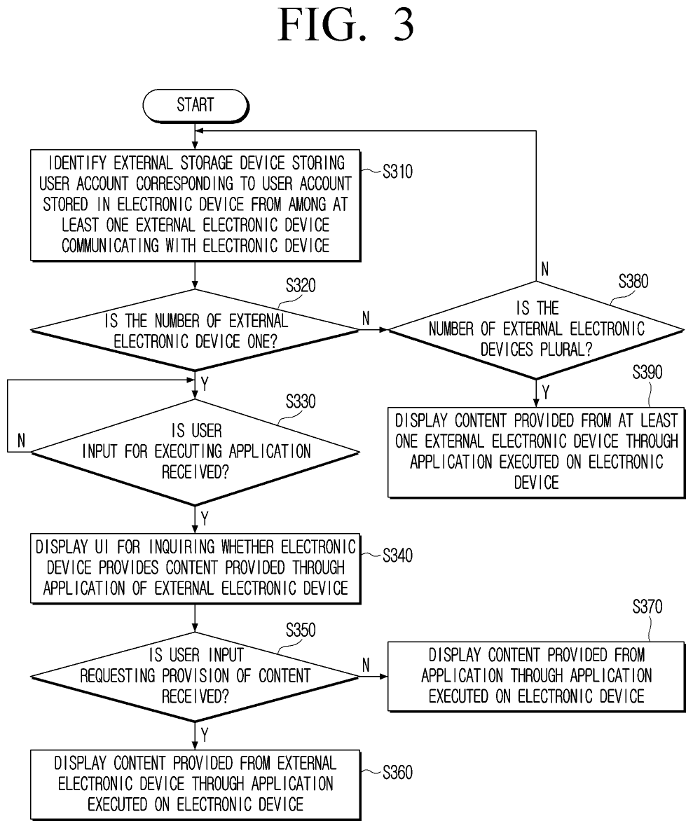

Specifically, the processor 130 may provide the continue-watching function for content, and will be described in more detail below with reference to the accompanying FIGS. 3 to 12.

First, referring to FIG. 3, the processor 130 may identify the external electronic device that stores a user account corresponding to the user account stored in the electronic device 100 among at least one external electronic device that performs communication with the communication interface 110 (S310).

To this end, the processor 130 may control the communication interface 110 to be communicatively connected to the external electronic device present around the electronic device 100.

In addition, the processor 130 may receive the information on the user account stored in the external electronic device from the external electronic device through the communication interface 110. To this end, the processor 130 may transmit a signal requesting transmission of the user account to the external electronic device through the communication interface 110. Alternatively, the external electronic device may transmit the information on the user account to the electronic device 100 without a separate request. Meanwhile, when the plurality of external electronic devices are communicatively connected to each other through the communication interface 110, the processor 130 may receive information on user accounts stored in each external electronic device from each external electronic device through the communication interface 110.

Thereafter, the processor 130 may identify whether the user account received from the external electronic device corresponds to the user account stored in the electronic device 100. Further, the processor 130 may identify the external electronic device that stores the user account corresponding to the user account stored in the electronic device 100 among at least one external electronic device that performs the communication with the communication interface 110.

Here, the correspondence of the user account may mean that the user account received from the external electronic device is the same as the user account stored in the electronic device 100. In other words, it may mean that the user accounts used when logging into the website are the same as each other. In this case, the user account may be an e-mail address, a phone number, etc.

Specifically, the processor 130 may compare the user account stored in the electronic device 100 with the user account received from the external electronic device, identify whether the user account stored in the electronic device 100 is the same as the user account received from the same external electronic device, and identify the external electronic device in which the same user account is stored.

Further, when a user input for executing an application of the electronic device 100 is received, the processor 130 may control the display 120 to display a user interface (UI) for inquiring whether the electronic device 100 will provide content provided through the application of the identified external electronic device.

Here, the processor 130 may control the display 120 to display the UI when there is only one identified external electronic device.

Specifically, when there is one external electronic device storing the same user account as the user account stored in the electronic device 100 among at least one external electronic device communicatively connected to the communication interface 110 (S320—Y) and a user input for executing an application is received (S330—Y), the processor 130 may display the UI for inquiring whether the electronic device 100 will provide the content provided through the application of the external electronic device.

Here, the user input may include a user input for selecting an icon for the application displayed on the display 120.

Further, when a user input requesting provision of content is received through the UI (S350—Y), the processor 130 may control the display 120 to display content provided from the identified external electronic device through the application executed on the electronic device 100 based on the information on the content received from the identified external electronic device (S360).

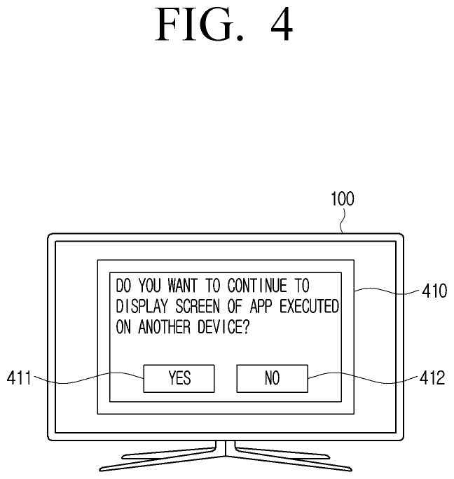

For example, as illustrated in FIG. 4, the processor 130 may display a UI 410 including text such as “Do you want to continue displaying the screen of the app executed on another device?” on the display 120. Further, when a user input for selecting “YES” 411 included in the UI 410 is received, the processor 130 may control the display 120 to display the content provided from the external electronic device through the application executed on the electronic device 100.

Here, the content provided from the external electronic device may be content most recently displayed on the display of the external electronic device through the application of the external electronic device.

For example, it is assumed that the application is the web browser application. In this case, the content provided from the external electronic device may be a web page currently being displayed on the display of the external electronic device through the web browser application.

As another example, it is assumed that the application is a photo application. In this case, the content provided from the external electronic device may be an image currently being displayed on the display of the external electronic device through a photo application.

As another example, it is assumed that the application is a note application. In this case, the content provided from the external electronic device may be a note page currently being displayed on the display of the external electronic device through the note application.

In addition, the content provided from the external electronic device may include a plurality of pieces of content provided through the application of the external electronic device. In this case, the plurality of pieces of content may include content displayed on the display of the external electronic device through the application of the external electronic device and at least one content executed in the background of the application.

For example, it is assumed that the application is the web browser application. In this case, the external electronic device may display one web page on the display of the external electronic device through the web browser application, and may execute at least one web page in the background even if it is not currently displayed on the display. In this case, the content provided from the external electronic device may include a plurality of web pages in the foreground and background states.

In addition to the above-described examples, the content may include various types of content that may be provided through various applications installed on the electronic device 100 and the external electronic device.

Meanwhile, the processor 130 may display the content provided from the external electronic device using the information on the content received from the external electronic device.

To this end, the processor 130 may receive the information on the content from the external electronic device through the communication interface 110.

Specifically, the processor 130 may transmit a signal requesting transmission of the information on the content provided from the external electronic device to the external electronic device through the communication interface 110. Accordingly, the external electronic device may transmit the information on the content provided through the application executed on the external electronic device to the electronic device 100.

For example, it is assumed that the web browser application is executed on the external electronic device, and a user input for executing the web browser application of electronic device 100 is input to the electronic device 100.

In this case, the processor 130 may transmit a signal requesting a URL for a web page provided by the web browser application from the external electronic device to the external electronic device through the communication interface 110. Accordingly, the external electronic device may transmit the URL for the web page displayed on the display of the external electronic device to the electronic device 100. In addition, when there is at least one web page in the background state, the external electronic device may transmit the URLs for these web pages to the electronic device 100. Accordingly, the processor 130 may receive information on the URL through the communication interface 110.

As another example, it is assumed that a photo application is executed on the external electronic device, and the user input for executing the photo application of the electronic device 100 is input to the electronic device 100.

Specifically, the processor 130 may transmit a signal requesting an image provided from the external electronic device through the photo application to the external electronic device through the communication interface 110. Accordingly, the external electronic device may transmit the image displayed on the display of the external electronic device to the electronic device 100. In addition, in addition to the image currently displayed on the display of the external electronic device, the external electronic device may transmit a plurality of thumbnails of a plurality of images stored in the external electronic device to the electronic device 100. Accordingly, the processor 130 may receive an image displayed on the external electronic device and the plurality of thumbnails for the plurality of images stored in the external electronic device through the communication interface 110.

As another example, it is assumed that the note application is executed on the external electronic device, and the user input for executing the note application of the electronic device 100 is input to the electronic device 100.

In this case, the processor 130 may transmit a signal requesting the note page provided from the external electronic device trough the note application to the external electronic device through the communication interface 110. Accordingly, the external electronic device may transmit the note page displayed on the display of the external electronic device to the electronic device 100. In addition to the note page currently displayed on the display of the external electronic device, the external electronic device may transmit the note pages stored in the external electronic device to the electronic device 100. Accordingly, the processor 130 may receive the note page displayed on the external electronic device and the note pages stored in the external electronic device through the communication interface 110.

As another example, it is assumed that a video streaming application is executed on the external electronic device and a user input for executing the video streaming application of the electronic device 100 is input to the electronic device 100.

In this case, the processor 130 may transmit a signal requesting information on a video provided through the video streaming application from the external electronic device to the external electronic device through the communication interface 110. Here, the information on the video may include a name of the video, a current playback time, etc. Accordingly, the processor 130 may receive the information on the video being played from the external electronic device through the communication interface 110.

In addition, the processor 130 may display the content provided from the external electronic device through the application using the information on the content received from the external electronic device.

Specifically, the processor 130 may execute the application and provide the content provided from the external electronic device through the application executed on the electronic device 100 using the information on the content.

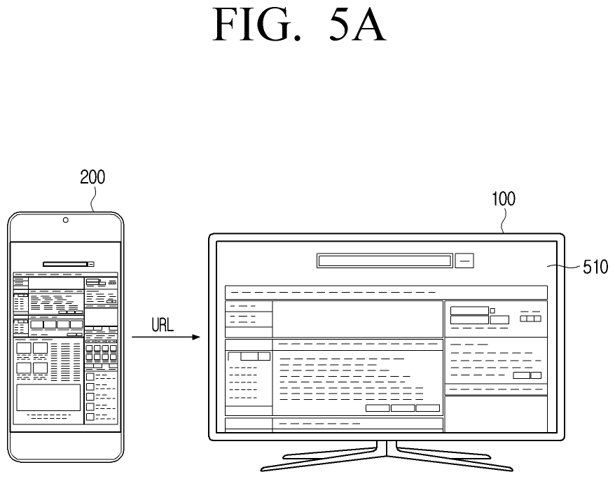

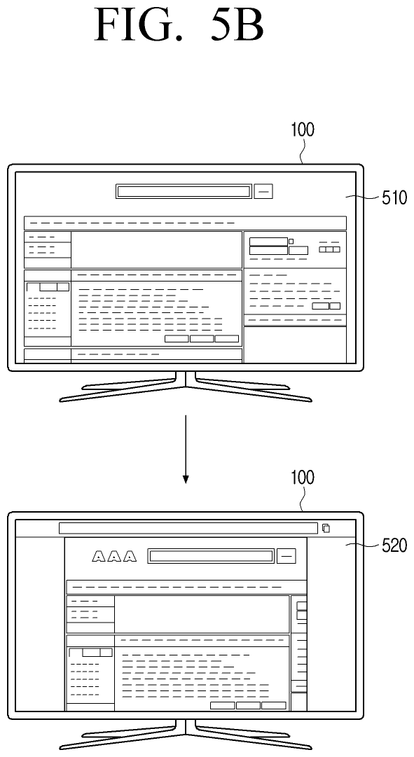

For example, when the user input for executing the web browser application is received, the processor 130 may execute the web browser application. As illustrated in FIG. 5a, the processor 130 may display a web page 510 using a URL received from the external electronic device 200 through the web browser application.

The processor 130 may perform an operation corresponding to the user input that is input to the web browser application. For example, as illustrated in FIG. 5B, when a user input for selecting an item included in a web page is received, the processor 130 may display a web page 520 using an address linked to the item.

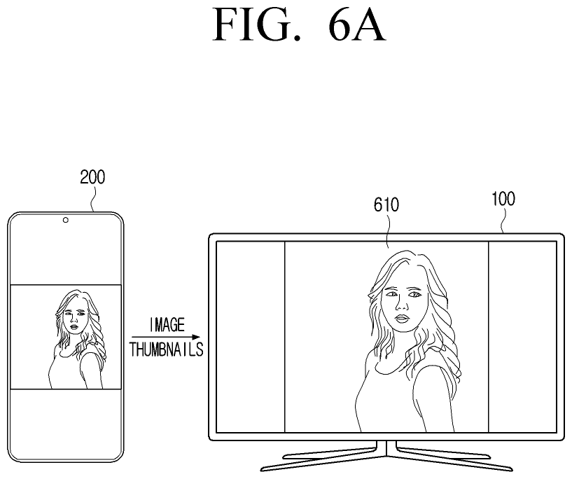

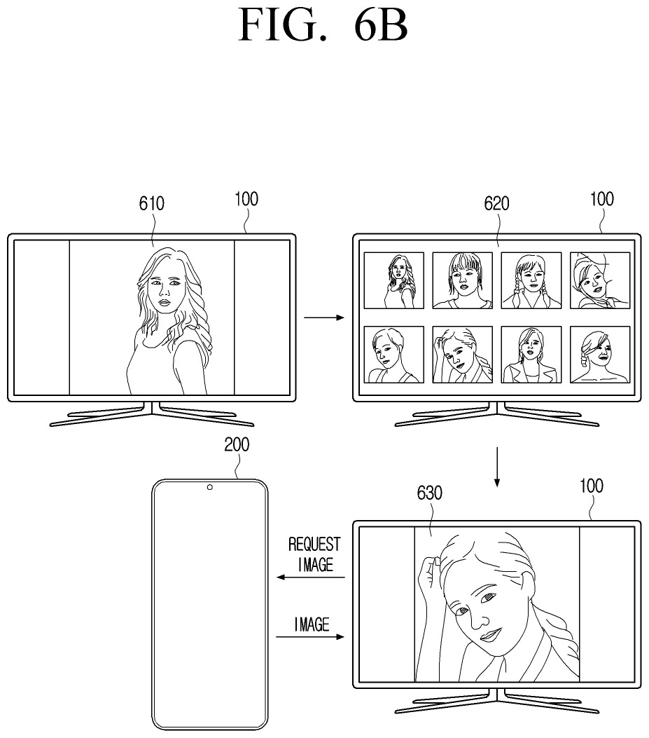

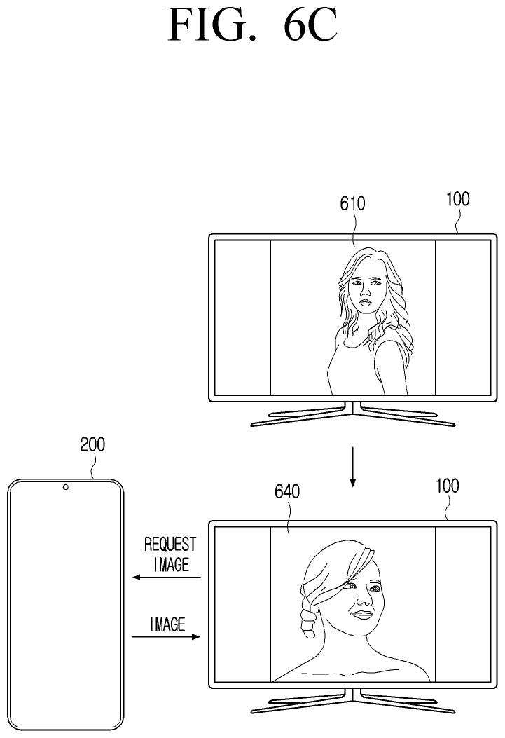

As another example, when the user input for executing the photo application is received, the processor 130 may execute the photo application. As illustrated in FIG. 6A, the processor 130 may display an image 610 received from the external electronic device 200 through the photo application.

The processor 130 may perform an operation corresponding to the user input that is input to the photo application. For example, as illustrated in FIG. 6B, when a user input for displaying all images is received, the processor 130 may display a plurality of thumbnails 620 for a plurality of images received from the external electronic device 200 through the photo application. When the user input for selecting one of the plurality of thumbnails 620 is received, the processor 130 may transmit a signal requesting an image for the selected thumbnail to the external electronic device 200 through the communication interface 110. Accordingly, the external electronic device 200 may transmit the image to the electronic device 100, and the processor 130 may display the image 630 received from the external electronic device 200 through the photo application. As another example, as illustrated in FIG. 6C, when the user input for displaying another image is received while the image 610 is displayed, the processor 130 may transmit a signal requesting another image to the external electronic device 200 through the communication interface 110. Here, another image may be a next image or a previous image of the image displayed on the electronic device 100. Accordingly, the external electronic device 200 may transmit the image to the electronic device 100, and the processor 130 may display an image 640 received from the external electronic device 200 through the photo application.

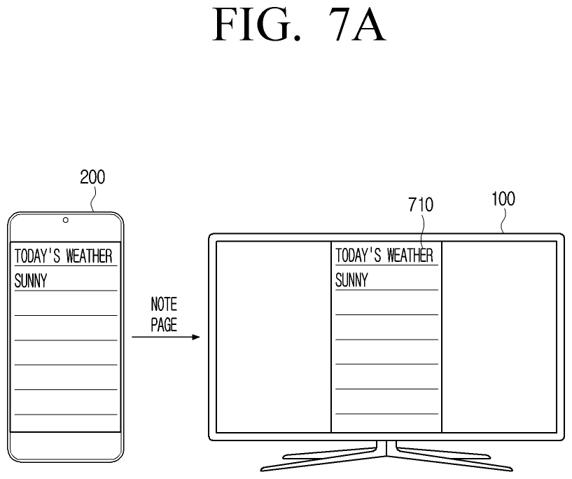

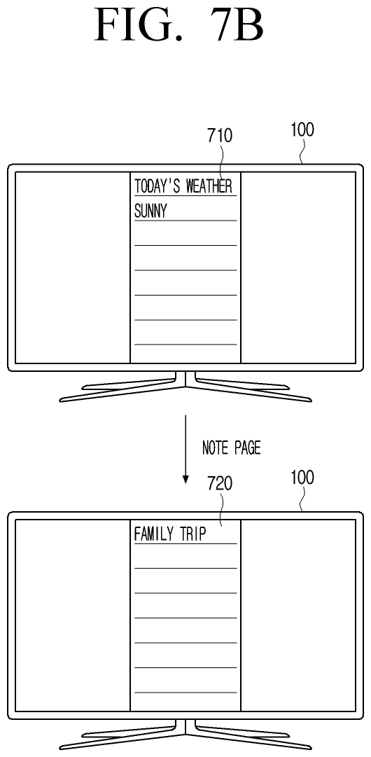

As another example, when the user input for executing the note application is received, the processor 130 may execute the note application. As illustrated in FIG. 7A, the processor 130 may display a note page 710 received from the external electronic device 200 through the note application.

The processor 130 may perform an operation corresponding to the user input that is input to the note application. For example, as illustrated in FIG. 7B, when a user input for displaying another note page is received while the note page 710 is displayed, the processor 130 may identify another note page among the note pages received from the external electronic device 200 and display another note page 720 through the note application. Here, another note page may be a next note page or a previous note page of the note page displayed on the electronic device 100.

Meanwhile, when a plurality of pieces of content are provided through the application of the identified external electronic device, the processor 130 may control the display 120 to display a UI for selecting at least one of the plurality of pieces of content based on information on the plurality of pieces of content received from the identified external electronic device.

Here, as an example, the plurality of pieces of content may be a plurality of web pages. The plurality of web pages may be a plurality of web pages in the foreground and background state in the web browser application of the external electronic device.

In this case, the processor 130 may receive a plurality of URLs for the plurality of web pages from the external electronic device through the communication interface 110, and display a UI for selecting at least one of the plurality of URLs.

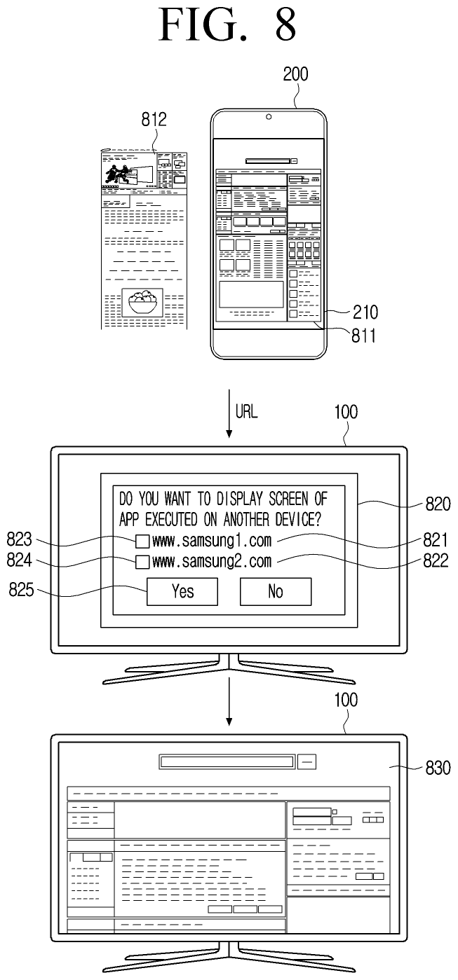

For example, as illustrated in FIG. 8, the external electronic device 200 may display one web page 811 on the display 210 and execute another web page 812 in the background through the web browser application. In this case, the external electronic device may transmit URLs for the web pages 811 and 812, such as “www.samsung1.com” and “www.samsung2.com”, to the electronic device 100.

In this case, the processor 130 may display a UI 810 including URLs 821 and 822 and objects (e.g., check boxes) 823 and 824 for selecting the URLs.

Then, when the user input for selecting content is received through the UI, the processor 130 may control the display 120 to display the selected content through the application executed on the electronic device 100 based on the information on the selected content.

Specifically, the processor 130 may display a web page using a selected URL from among a plurality of URLs through the web browser application.

For example, in FIG. 8, it is assumed that a user input for selecting objects 823 for “www.samsung1.com” and “YES” 825 is received. In this case, the processor 130 may display a web page 830 received from “www.samsung1.com” through the web browser application.

Meanwhile, when plurality of pieces of content are provided through an application of an identified external electronic device, the processor 130 may control the display 120 to display the plurality of pieces of content through the application executed on the electronic device based on the information on plurality of pieces of content received from the identified external electronic device.

In this case, the processor 130 may provide information on the plurality of pieces of content by configuring the information into a single screen.

For example, when the web browser application is executed, the processor 130 may display a main screen provided by the web browser application on the display 120. In this case, a main screen may include an address bar, tabs, etc. Here, a tab may include a favorite tab for a web page set as a favorite, a bookmark tab for a bookmarked web page, etc.

In this case, the processor 130 may generate a new tab on the main screen of the web browser application. Here, the new tab may be a tab for a screen including a plurality of items linked to the plurality of URLs received from the external electronic device. The processor 130 may display a screen including the plurality of items. When a user input for selecting one of a plurality of items is received, the processor 130 may display a web page using a URL linked to the selected item.

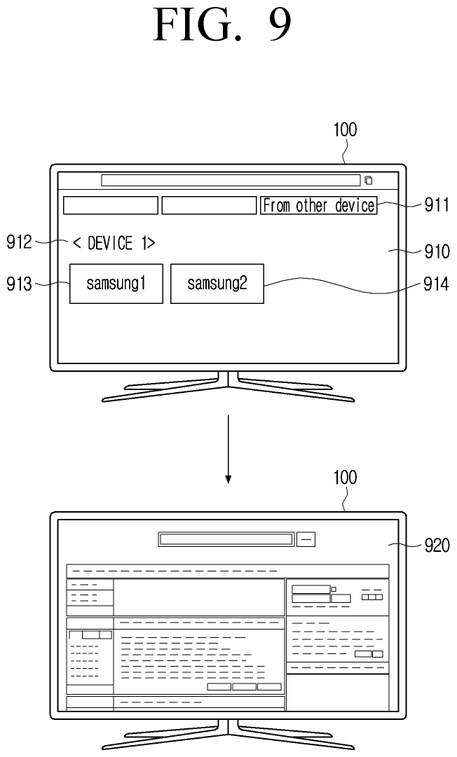

For example, it is assumed that the external electronic device transmits the plurality of URLs (e.g., “www.samsung1.com”, “www.samsung2.com”) for the plurality of web pages to the electronic device 100. In this case, as illustrated in FIG. 9, the processor 130 may generate a new tab 911 such as “from other device” in the web browser application and display a screen 910 for the new tab. In this case, the screen 910 may include a name 912 of the external electronic device, an item 913 linked to “www.samsung1.com”, and an item 914 linked to “www.samsung2.com”. When the processor 130 receives a user input for selecting the item 913, it may display a web page 920 received from “www.samsung1.com” through the web browser application.

Meanwhile, referring back to FIG. 3, when a user input that does not request provision of content is received through the UI (S350—N), the processor 130 may control the display 120 to display the content provided by the application through the application executed on the electronic device 100 (S370).

For example, in FIG. 4, when a user input for selecting “NO” 412 included in the UI 410 is received, the processor 130 may control the display 120 to display the content provided through the application executed on the electronic device 100.

Here, the content may be content provided by itself through the application of the electronic device 100, not content provided through the application of the external electronic device.

For example, the content may include a web page displayed through the URL input to the web browser application of the electronic device 100 in the case of the web browser application. As another example, the content may include an image stored in the electronic device 100 in the case of the photo application. As another example, in the case of the note application, the content may include the note page generated through the note application of the electronic device 100.

Meanwhile, when there are the plurality of external electronic devices that have the same user account stored in the electronic device 100 among at least one external electronic device that is communicatively connected to the communication interface 110 (S320—N and S380—Y), the processor 130 may control the display 120 to display the content provided from at least one external electronic device through the application executed in the electronic device 100 based on the information on the content received from the at least one external electronic device (S390).

Specifically, when there are the plurality of identified external electronic devices, the processor 130 may control the display 120 to display the UI for selecting one of the plurality of identified external electronic devices.

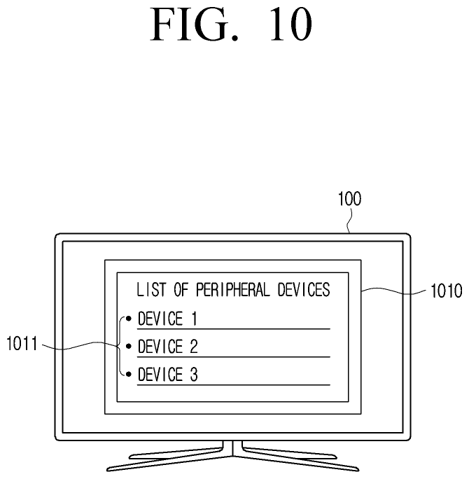

For example, as illustrated in FIG. 10, the processor 130 may display a UI 1010 including names 1011 of the plurality of external electronic devices that have the same user account stored in the electronic device 100.

When the user input for selecting the external electronic device is received through the UI, the processor 130 may control the display 120 to display the content provided from the selected external electronic device through the application executed on the electronic device 100 based on the information on content received from the selected external electronic device. Specifically, when the user input for selecting the external electronic device is received through the UI, the processor 130 may transmit the signal requesting the transmission of the information on the content provided from the external electronic device to the selected external electronic device through the communication interface 110. Accordingly, the selected external electronic device may transmit the information on the content provided through the application executed on the external electronic device to the electronic device 100.

Meanwhile, a method for providing content by using information on content transmitted from the external electronic device to the electronic device 100 and information on content received by the processor 130 is as described above.

For example, when the plurality of pieces of content are provided through the application of the external electronic device, the processor 130 may display the UI for selecting at least one of the plurality of pieces of content based on the information on the plurality of pieces of content received from the external electronic device, and when the user input for selecting the content is received through the UI, the display 120 may be controlled to display the selected content through the application executed on the electronic device 100 based on the information on the selected content.

Here, as an example, the plurality of pieces of content may be a plurality of web pages. As another example, the plurality of pieces of content may be the plurality of thumbnails. As another example, the plurality of pieces of content may be the plurality of note pages.

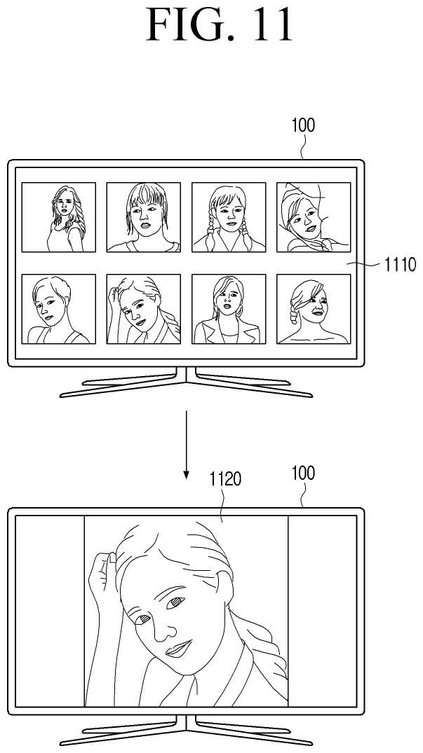

For example, as illustrated in FIG. 11, the processor 130 may display a plurality of thumbnails 1110 received from the external electronic device selected through the UI. When the user input for selecting one of the plurality of thumbnails 620 is received, the processor 130 may transmit a signal requesting an image for the selected thumbnail to the external electronic device 200 through the communication interface 110. Accordingly, the external electronic device may transmit an image to the electronic device 100, and the processor 130 may display an image 1120 received from the external electronic device through the photo application.

Meanwhile, when there are the plurality of identified external electronic devices, the processor 130 may control the display 120 to display the content provided through the application of each external electronic device through the application executed in the electronic device based on the information on the content received from each of the plurality of identified external electronic devices.

In this case, when the application executed in each external electronic device is the web browser application, the processor 130 may generate a new tab on the main screen of the web browser application executed in the electronic device 100, and display a screen for the new tab. In this case, the screen for the new tab may include an item linked to at least one URL received from each external electronic device. When a user input for selecting one of a plurality of items is received, the processor 130 may display a web page using a URL linked to the selected item.

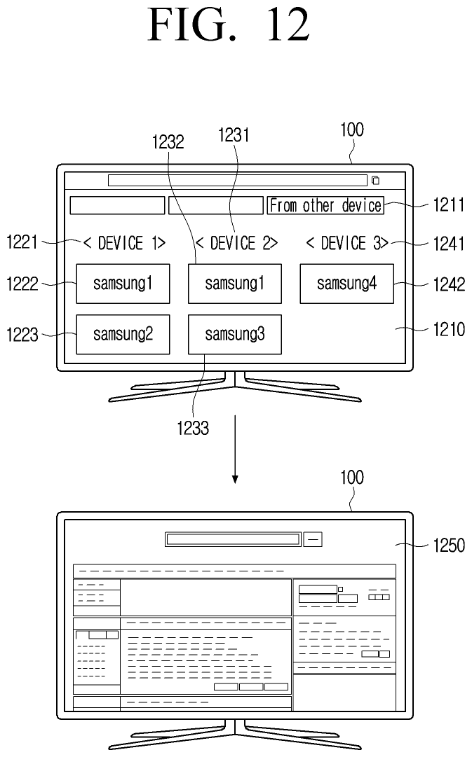

For example, it is assumed that a first external electronic device transmits a plurality of URLs for the plurality of web pages (e.g., “www.samsung1.com”, “www.samsung2.com”) to the electronic device 100, a second external electronic device transmits the plurality of URLs for the plurality of web pages (e.g., “www.samsung1.com”, “www.samsung3.com”) to the electronic device 100, and a third external electronic device transmits a URL for a web page (e.g., “www.samsung4.com”) to the electronic device 100. In this case, as illustrated in FIG. 12, the processor 130 may generate a new tab 1211 such as “from other device” in the web browser application and display a screen 1210 for the new tab. In this case, the screen 1210 may include a name 1221 of a first external electronic device, a plurality of items (i.e., item 1222 linked to “www.samsung1.com”, item 1223 linked to “www.samsung2.com”) linked to a plurality of web pages provided by the first external electronic device, a name 1231 of a second external electronic device, a plurality of items (i.e., item 1232 linked to “www.samsung1.com”, item 1233 linked to “www.samsung3.com”) linked to a plurality of web pages provided by the second external electronic device, a name 1241 of a third external electronic device, and an item (i.e., item 1242 linked to “www.samsung4.com”) linked to a web page provided by the third external electronic device. In this way, the processor 130 may display items for web pages provided for each external electronic device, for each external electronic device. When the processor 130 receives a user input for selecting the item 1221, it may display a web page 1250 received from “www.samsung1.com” through the web browser application.

In this way, according to an embodiment of the present disclosure, the user convenience may be improved in that the continue-watching function for content provided through the application of the external electronic device is provided through the application of the electronic device. In addition, the user may be inquired whether the electronic device will provide the content provided from the external electronic device, and when the user requests the provision of the content, the continue-watching of the content may be provided. In addition, the continue-watching function for the content may be provided in various ways depending on whether there is one or more external electronic devices, so the continue-watching of the content may be provided in a way that better suits the user's intention.

Meanwhile, in the above-described example, the content provided through the application of the external electronic device in which the same user account as the user account stored in the electronic device 100 is stored is described as being provided through the application of the electronic device 100, but this is only an example. That is, even if the user account is not the same as the user account of the electronic device 100, the electronic device 100 may provide the continue-watching of the content provided through the application of the external electronic device that is connected to (i.e., paired with) the electronic device 100.

In addition, in the above-described example, the electronic device 100 is described as receiving the information on the content from the external electronic device, but this is only an example. For example, the external electronic device may access a website provided by the server through the user account and upload the information on the content provided through the application of the external electronic device to the server. In this case, since the user account stored in the electronic device 100 is the same as the user account stored in the external electronic device, the electronic device 100 may access the website provided by the server through the user account and acquire the information on the content provided through the application of the external electronic device from the server. In addition, the electronic device 100 may provide the continue-watching of the content by using the information on the content acquired from the server.

In addition, in the above-described example, it was described that the content displayed on the external electronic device is continuously provided on electronic device 100. That is, it was described that the content provided through the application running in the foreground state on the external electronic device is provided on the electronic device 100. However, this is only an example, and the content provided by one of the plurality of applications executed in the foreground and background states on the external electronic device may be provided on the electronic device 100.

Specifically, when the plurality of pieces of content are provided through the plurality of applications of the external electronic device, the processor 130 may control the display 120 to display the UI for selecting one of the plurality of applications based on the information on the plurality of applications received from the external electronic device.

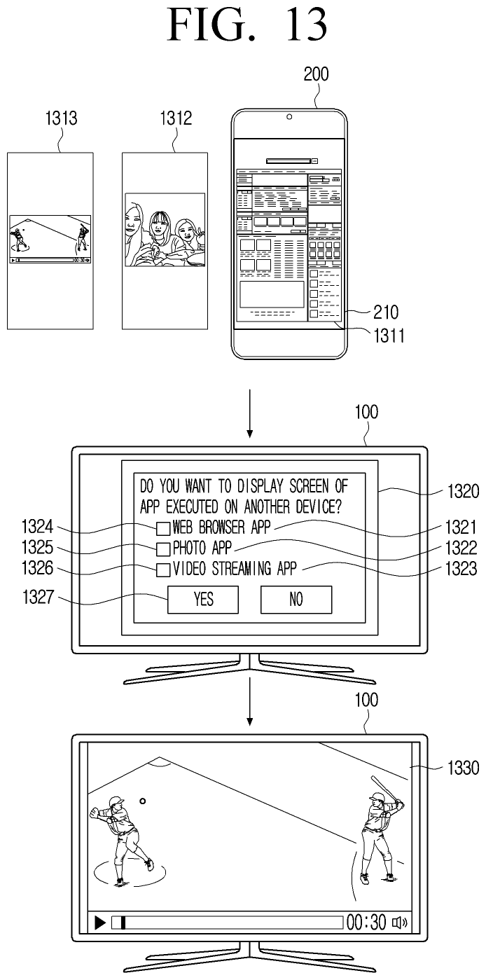

For example, as illustrated in FIG. 13, it is assumed that the external electronic device 200 displays the web page on the display 210 through the web browser application 1311 and executes the photo application 1312 and the video streaming application 1313 in the background state. In this case, the external electronic device 200 may transmit information on an application executed on the external electronic device 200 (e.g., the name of the application) and information on content provided through the application to the electronic device 100.

In this case, the processor 130 may display a UI 1320 including a plurality of applications 1321, 1322, and 1323 and objects 1324, 1325, and 1326 (e.g., check boxes) for selecting a plurality of applications.

Then, when the user input for selecting the application is received through the UI, the processor 130 may execute the corresponding application on the electronic device 100 based on the information on the selected application. Then, the processor 130 may provide the content provided through the application of the external electronic device 200 through the application executed on the electronic device 100.

For example, in FIG. 13, it is assumed that the user input for selecting the object 1323 and “YES” 1327 for the video streaming application is received. In this case, the processor 130 may execute the video streaming application and display the video 1330 being played on the external electronic device through the video streaming application executed on the electronic device 100 using the name of the video received from the external electronic device 200, the current playback time, etc.

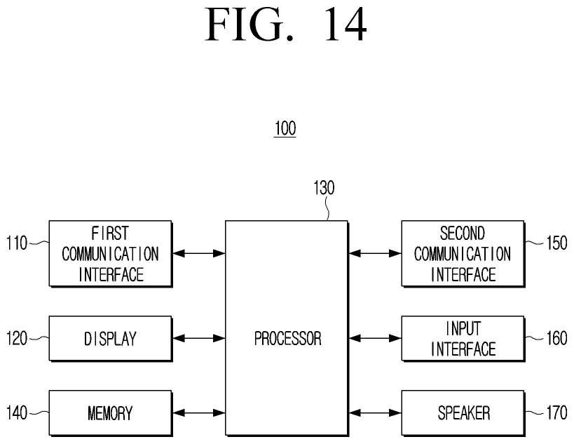

FIG. 14 is a block diagram for describing a detailed configuration of the electronic device according to an embodiment of the present disclosure.

Referring to FIG. 14, the electronic device 100 may include a memory 140, a second communication interface 150, an input interface 160, and a speaker 170 as well as the first communication interface 110, the display 120, and the processor 130. However, such components are only examples, and new components may be added to such components or some of such components may be omitted in practicing the disclosure. Meanwhile, in describing FIG. 14, descriptions overlapping with FIGS. 1 to 13 will be omitted.

The memory 140 may store at least one instruction and at least one software program for driving the electronic device 100. In this case, the memory 150 may include a semiconductor memory such as a flash memory. Meanwhile, in the disclosure, the term memory 140 may be used as the meaning including the memory 140, a read only memory (ROM) (not illustrated) in the processor 130, a random access memory (RAM) (not illustrated), or a memory card (not illustrated) (for example, a micro secure digital (SD) card or a memory stick) mounted in the electronic device 100.

Meanwhile, the memory 140 may store data related to the electronic device 100. For example, the memory 140 may store the information on the user account. The memory 140 may store information on a web page where a login is performed through the user account.

The second communication interface 150 includes a circuit. The second communication interface 150 may communicate with the server. To this end, the second communication interface 150 may include a Wi-Fi module and may communicate with the server through a network using a Wi-Fi communication method. Accordingly, the processor 130 may receive various types of data from the server through the second communication interface 150. For example, the processor 130 may access a website provided by the server through the user account, and may receive the information on the content provided from the server through the application of the external electronic device through the second communication interface 150.

The input interface 160 includes a circuit. The user interface 160 may receive the user input. For example, the input interface 160 may be configured with a plurality of buttons. As another example, the input interface 160 may receive a remote control signal from a remote control for controlling the electronic device 100. As another example, the input interface 160 may be implemented as a touch screen. In this case, when the user input is received through the input interface 160, the processor 130 may perform an operation corresponding to the user input.

The speaker 170 may output audio. Specifically, the processor 130 may output various notification sounds or voice guidance messages related to the operation of the electronic device 100 through the speaker 170.

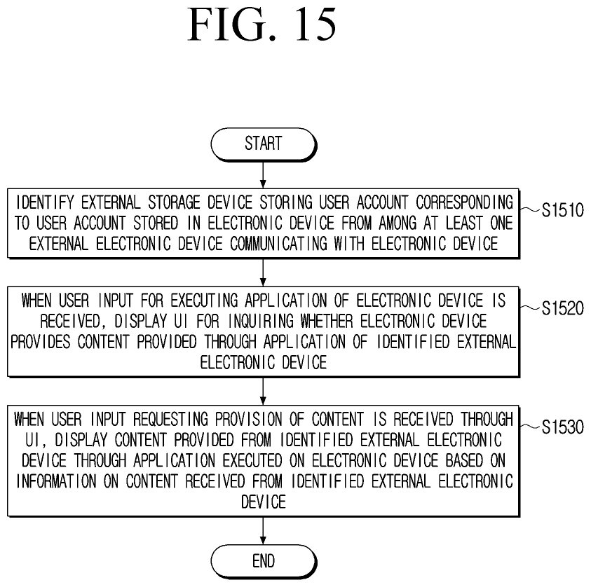

FIG. 15 is a flowchart for describing a control method for an electronic device for providing a continue-watching function for content according to an embodiment of the present disclosure.

The external electronic device that stores the user account corresponding to the user account stored in the electronic device is identified from among at least one external electronic device that performs the communication with the electronic device (S1510).

Thereafter, when the user input for executing the application of the electronic device is received, the UI is displayed for inquiring whether the electronic device will provide content provided through the application of the identified external electronic device (S1520).

When the user input requesting the provision of the content is received through the UI, the content provided from the identified external electronic device is displayed through the application executed in the electronic device based on the information on the content received from the identified external electronic device (S1530).

Here, the content provided from the identified external electronic device may be content most recently displayed on the display of the identified external electronic device through the application of the external electronic device.

In addition, the content provided from the identified external electronic device includes a plurality of pieces of content provided through the application of the identified external electronic device, and the plurality of pieces of content may include the content displayed on the display of the identified external electronic device through the application of the identified external electronic device and at least one content being executed in the background of the application.

Meanwhile, in operation S1520, when the number of identified external electronic devices is one, the UI may be displayed.

In addition, in operation S1530, when the plurality of pieces of content are provided through the application of the identified external electronic device, the UI for selecting at least one of the plurality of pieces of content may be displayed based on the information on the plurality of pieces of content received from the identified external electronic device, and when the user input for selecting the content is received through the UI, the selected content may be displayed through the application executed on the electronic device based on information on the selected content.

In addition, in operation S1530, when the plurality of pieces of content are provided through the application of the identified external electronic device, the plurality of pieces of content may be displayed through the application executed on the electronic device based on the information on the plurality of pieces of content received from the identified external electronic device.

Meanwhile, when there are the plurality of identified external electronic devices, the UI for selecting one of the plurality of identified external electronic devices is displayed, and when the user input for selecting the external electronic device is received through the UI, the content provided from the selected external electronic device may be displayed through the application executed on the electronic device based on information on the content received from the selected external electronic device.

In addition, when there are the plurality of identified external electronic devices, the content provided through the application of each of the external electronic devices may be displayed through the application executed on the electronic device based on the information on the content received from each of the plurality of identified external electronic devices.

According to an embodiment, the methods according to various embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™) or may be directly distributed (for example, download or upload) between two user devices (for example, smart phones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Each of components (for example, modules or programs) according to the diverse embodiments of the disclosure as described above may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner.

Operations performed by the modules, the programs, or other components according to the diverse embodiments may be executed in a sequential manner, a parallel manner, an iterative manner, or a heuristic manner, at least some of the operations may be performed in a different order or be omitted, or other operations may be added.

Meanwhile, the term “unit” or “module” used in the disclosure may include units configured by hardware, software, or firmware, and may be used compatibly with terms such as, for example, logics, logic blocks, components, circuits, or the like. The term “˜er/or” or “module” may be an integrally configured component or a minimum unit performing one or more functions or a part thereof. For example, the module may be configured by an application-specific integrated circuit (ASIC).

Meanwhile, a non-transitory computer readable medium in which a program sequentially performing the controlling method according to the present disclosure is stored may be provided. The non-transitory computer readable medium is not a medium that stores data for a while, such as a register, a cache, a memory, or the like, but means a medium that semi-permanently stores data and is readable by an apparatus. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

In addition, the embodiments of the present disclosure may be implemented by software including instructions stored in a machine-readable storage medium (for example, a computer-readable storage medium). A machine may be an apparatus that invokes the stored instruction from the storage medium and may be operated depending on the invoked instruction, and may include the electronic device (for example, the electronic device 100) according to the disclosed embodiments.

In a case where a command is executed by the processor, the processor may directly perform a function corresponding to the command or other components may perform the function corresponding to the command under a control of the processor. The command may include codes created or executed by a compiler or an interpreter.

Hereinafter, although exemplary embodiments of the present disclosure have been illustrated and described, the present disclosure is not limited to the above-described specific exemplary embodiments, but may be variously modified by those skilled in the art to which the present disclosure pertains without departing from the gist of the present disclosure as disclosed in the accompanying claims. These modifications should also be understood to fall within the scope and spirit of the present disclosure.

1. An electronic device, comprising:
a communication interface;
a display; and
at least one processor configured to:
identify an external electronic device storing information related to a user account that is stored in the electronic device from among at least one external electronic device enabled to perform communication with the communication interface,
control the display to display a user interface (UI) for inquiring whether the electronic device provides content provided through a first application of the identified external electronic device based on a user input executing a second application of the electronic device being received, and
control the display to display the content provided from the identified external electronic device, through the second application executed on the electronic device, based on information related to the content received from the identified external electronic device upon a user input requesting provision of the content being received through the UI,
wherein the second application corresponds to the first application.

2. The electronic device as claimed in claim 1, wherein the content provided from the identified external electronic device is content most recently displayed on the display of the identified external electronic device through the first application of the identified external electronic device.

3. The electronic device as claimed in claim 1, wherein the content provided from the identified external electronic device is among a plurality of pieces of content provided through the first application of the identified external electronic device, and
the plurality of pieces of content include content displayed on the display of the identified external electronic device through the first application of the identified external electronic device and at least one content is executed in a background of the first application.

4. The electronic device as claimed in claim 1, wherein based on a number of identified external electronic device being one, the processor is configured to control the display to display the UI.

5. The electronic device as claimed in claim 1, wherein based on a plurality of pieces of content being provided through the first application of the identified external electronic device,
the processor is configured to:
control the display to display a UI for selecting at least one of the plurality of pieces of content based on information related to the plurality of pieces of content received from the identified external electronic device, and
based on a user input selecting the content being received through the UI, control the display to display the selected content through the second application executed on the electronic device based on information related to the selected content.

6. The electronic device as claimed in claim 1, wherein based on a plurality of pieces of content being provided through the first application of the identified external electronic device, the processor is configured to control the display to display the plurality of pieces of content through the second application executed on the electronic device based on information related to the plurality of pieces of content received from the identified external electronic device.

7. The electronic device as claimed in claim 1, wherein the processor is configured to control the display to display a UI for selecting one of a plurality of identified external electronic devices based on a number of identified external electronic devices being plural, and
control the display to display content provided from the selected external electronic device through the second application executed on the electronic device based on information related to the content received from the selected external electronic device based on a user input selecting the external electronic device being received through the UI.

8. The electronic device as claimed in claim 1, wherein based on a number of identified external electronic devices being plural, the processor is configured to control the display to display the content provided through the first application of each of the external electronic devices through the second application executed on the electronic device based on the information related to the content received from each of the identified external electronic devices.

9. A control method for an electronic device for providing a continue-watching function for content, comprising:
identifying an external electronic device storing information related to a user account that is stored in an electronic device from among at least one external electronic device enabled to perform communication with the electronic device;
displaying a UI for inquiring whether the electronic device provides content provided through a first application of the identified external electronic device based on a user input executing a second application of the electronic device being received; and
displaying the content provided from the identified external electronic device, through the second application executed on the electronic device, based on information related to the content received from the identified external electronic device upon a user input requesting provision of the content being received through the UI,
wherein the second application corresponds to the first application.

10. The control method as claimed in claim 9, wherein the content provided from the identified external electronic device is content most recently displayed on the display of the identified external electronic device through the first application of the identified external electronic device.

11. The control method as claimed in claim 9, wherein the content provided from the identified external electronic device is among a plurality of pieces of content provided through the first application of the identified external electronic device, and
the plurality of pieces of content include content displayed on the display of the identified external electronic device through the first application of the identified external electronic device and at least one content being executed in a background of the first application.

12. The control method as claimed in claim 9, wherein in the displaying of the UI, based on a number of identified external electronic devices being one, the UI is displayed.

13. The control method as claimed in claim 9, wherein the displaying of the content includes:
displaying a UI for selecting at least one of a plurality of pieces of content based on information related to the plurality of pieces of content received from the identified external electronic device based on a plurality of pieces of content being provided through the first application of the identified external electronic device; and
displaying the selected content through the second application executed on the electronic device based on information related to the selected content based on a user input selecting the content being received through the UI.

14. The control method as claimed in claim 9, wherein the displaying of the content includes displaying a plurality of pieces of content through the second application executed on the electronic device based on the information related to the plurality of pieces of content received from the identified external electronic device based on a plurality of pieces of content being provided through the first application of the identified external electronic device.

15. The control method as claimed in claim 9, further comprising:
displaying a UI for selecting one of a plurality of identified external electronic devices based on a number of identified external electronic devices being plural; and
displaying the content provided from the selected external electronic device through the second application executed on the electronic device based on the information related to the content received from the selected external electronic device based on the user input selecting the external electronic device being received through the UI.

16. The control method as claimed in claim 9, further comprising:
wherein based on a number of identified external electronic devices being plural, displaying the content provided through the first application of each of the external electronic devices through the second application executed on the electronic device based on the information related to the content received from each of the identified external electronic devices.

17. A non-transitory computer readable recording medium storing computer instructions that cause an electronic device to perform an operation when executed by at least one processor of the electronic device, wherein the operation comprises;
identifying an external electronic device storing information related to a user account that is stored in an electronic device from among at least one external electronic device enabled to perform communication with the electronic device;
displaying a UI for inquiring whether the electronic device provides content provided through a first application of the identified external electronic device based on a user input executing a second application of the electronic device being received; and
displaying the content provided from the identified external electronic device, through the application executed on the electronic device, based on information related to the content received from the identified external electronic device upon a user input requesting provision of the content being received through the UI,
wherein the second application corresponds to the first application.

18. The medium as claimed in claim 17, wherein the content provided from the identified external electronic device is content most recently displayed on the display of the identified external electronic device through the first application of the identified external electronic device.

19. The medium as claimed in claim 17, wherein the content provided from the identified external electronic device is among a plurality of pieces of content provided through the first application of the identified external electronic device, and
the plurality of pieces of content include content displayed on the display of the identified external electronic device through the first application of the identified external electronic device and at least one content being executed in a background of the first application.

20. The medium as claimed in claim 17, wherein in the displaying of the UI, based on a number of identified external electronic devices being one, the UI is displayed.
